(19) United States
(12) Patent Application Publication
(10) Pub. No.: US 2024/0202103 A1
(43) Pub. Date: Jun. 20, 2024

(54) SYSTEM AND METHOD FOR AUTOMATING TESTING OF AN APPLICATION

(71) Applicant: SLK SOFTWARE PVT. LTD., Bagalore (IN)

(72) Inventors: Shankaranarayana H ADIGA, Bangalore (IN); Manish JHA, Bangalore (IN); Vijaykumar E. K, Bangalore (IN); Vidur AMIN, Spring, TX (US)

(21) Appl. No.: 18/390,478

(22) Filed: Dec. 20, 2023

(30) Foreign Application Priority Data
Dec. 20, 2022 (IN) 202241067750

(51) Int. Cl. G06F 11/36

(52) U.S. Cl. CPC G06F 11/3664; G06F 11/3684

(57) ABSTRACT

The present invention relates to a system and method for automating testing of an application. The system has a processor configured to monitor the application to capture input actions performed by a user on the application, analyze the input actions to determine a type of input action performed by the user, assign keywords to each of the input actions, determine a unique test script for each input action based on the assigned keyword, each keyword associated with a unique test script, the keywords and the associated unique test scripts for each input action are pre-determined and stored on a database, and store the unique test script associated with each of the input action on the database for replaying the unique test script during execution of automatic testing of the application. The processor is configured to generate a report to access the unique test script.

### CROSS-REFERENCE TO RELATED PATENT APPLICATION

This application claims priority to and the benefit of Indian Patent Application No. 202241067750, filed Dec. 20, 2022, which is incorporated herein in its entirety by reference.

### FIELD OF THE INVENTION

The present invention relates to a system and method for automating testing of an application.

### BACKGROUND OF THE INVENTION

Most organizations in the software industry need to spend a great

deal of time and resources in testing their applications. Testing is a process to identify failures in the application such as bugs and errors which can be rectified by application developers. Testing processes are undertaken by running dedicated tests that include customized scripts drafted in scripting languages such as Perl, Python, C#, Java and

JavaScript, which requires skill and expertise. A major challenge in creating these tests is that coding/drafting scripts is arduous and is immensely time-consuming. The challenge is amplified when a newer iteration/version of the application is created, or an error is detected in the application. In such an event, the test script needs to be modified, which is quite time consuming and requires tremendous skill on the part of the automation engineer. Another major drawback of creating such scripts is that in a single day, only one to two test cases can be created for automated testing, thereby delaying the entire testing process.

Over a period of time, testing systems have evolved to minimize and eliminate the time and effort required to code the test scripts. In such systems, the script is auto generated in the backend based on selection of certain parameters by the user. However, the testing and automation maintenance still involves a significant portion of manual intervention i.e., locating the exact test automation scenarios based on the changes in application under test and modifying the automation without impacting other portion of the automation scripts. Further, modifying the test script to correspond to a newer version of the application or an error in part of the script is a challenge that persists because current systems are not creating and maintaining the traceability of the application structure / workflow and associated automation.

Thus, there is a need in the art for a system and method for automating testing of an application which addresses at-least the aforementioned problems.

### SUMMARY OF THE INVENTION

In one aspect, the present invention relates to a system for automating testing of an application. The system has a database and a processor. The processor is configured to monitor the application to capture one or more input actions performed by a user on the application via one or more input devices connected with the processor and analyze the one or more input actions to determine a type of input action performed by the user. The processor is further configured to assign one or more keywords to each of the input actions performed by the user and determine a unique test script for each input action based on the assigned keyword. Herein, each keyword is associated with a unique test script, the keywords and the associated unique test scripts for each input action are pre-determined and stored on the database. The processor is further configured to store the unique test script associated with each of the input actions on the database for replaying the unique test script during execution of automatic testing of the application.

In an embodiment of the invention, the processor is configured to monitor a sequence of input actions performed by the user and generate a complete test script for sequence of input actions performed by the user.

The complete test script having individual unique test scripts for each of the input actions. The processor is further configured to store the complete test script on the database for replaying the complete test script during execution of automatic testing of the application.

In a further embodiment of the invention, the processor is configured to split a display screen into at least a first window and a second window. The first window configured to display the application being monitored whereby the user is performing one or more input actions. The second window is configured to display page information of the application, the keywords and the unique test scripts being assigned to one or more input actions performed by the user.

In a further embodiment of the invention, the analysis of one or more input actions performed by the user includes one of analyzing a type of element involved in the input action, a location of the element and validation of the input action provided by the user.

In a further embodiment of the invention, the processor is configured to generate a report comprising plurality of interactive links. Each interactive link provides access to the unique test script determined for each input action, enabling the user to navigate and modify the unique test script.

In a further embodiment of the invention, the report includes one or more modules arranged in a hierarchical structure corresponding to a hierarchical structure of the application. The one or more modules has a main module corresponding to a parent node and each of the one or more sub modules corresponding to a child node of the parent node. Each of the one or more modules includes an interactive link.

In another aspect, the present invention relates to a method for automating testing of an application. The method has the steps of monitoring, by a processor, the application to capture one or more input actions performed by a user on the application via one or more input devices connected with the processor and analyzing, by the processor, the one or more input actions to determine a type of input action performed by the user. The method further has steps of assigning, by the processor, one or more keywords to each of the input actions performed by the user and determining, by the processor, a unique test script for each input action based on the assigned keyword. Herein, each keyword is associated with a unique test script, the keywords and the associated unique test scripts for each input action are pre-determined and stored on a database. The method further has step of storing, by the processor, the unique test script associated with each of the input actions on the database for replaying the unique test script during execution of automatic testing of the application.

In an embodiment of the invention, the method has the steps of monitoring, by the processor, a sequence of input actions performed by the user and generating, by the processor, a complete test script for sequence of input actions performed by the user, the complete test script having individual unique test scripts for each of the input actions. The method further has the step of storing, by the processor, the complete test script on the database for replaying the complete test script during execution of automatic testing of the application.

In a further embodiment of the invention, the method has the step of splitting, by the processor, a display screen into at least a first window and a second window. The first window configured to display the application being monitored whereby the user is performing one or more input actions. The second window is configured to display page information of the application, the keywords and the unique test scripts being assigned to one or more input actions performed by the user.

In a further embodiment of the invention, the analysis of one or more input actions performed by the user includes one of analyzing a type of element involved in the input action, a location of the element and validation of the input action provided by the user.

In a further embodiment of the invention, the method has the step of generating, by the processor, a report comprising plurality of interactive links. Each interactive link provides access to the unique test script determined for each input action, enabling the user to navigate and modify the unique test script.

In a further embodiment of the invention, the report includes one or more modules arranged in a hierarchical structure corresponding to a hierarchical structure of the application. The one or more modules has a main module corresponding to a parent node and each of the one or more sub modules corresponding to a child node of the parent node. Each of the one or more modules includes an interactive link.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 illustrates a system for automating testing of an application in accordance with an embodiment of the invention.

FIG. 2 illustrates a report generated in accordance with an embodiment of the invention.

FIG. 3 illustrates a method for automating testing of an application in accordance with an embodiment of the invention.

### DETAILED DESCRIPTION OF THE INVENTION

The present invention is directed towards a system and method for automating testing of an application whereby a unique test script is generated by simply using or navigating the application under test. The present invention also generates a report which is structured and interactive, enabling users to understand test scenarios and flow of the application visually. The report also allows users to edit part or whole of the test script for modifying the test script which may have bugs/errors or in cases where the application has been updated/modified.

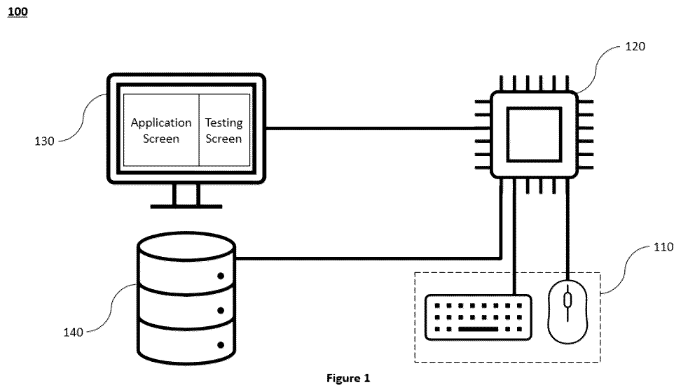

FIG. 1 illustrates a system 100 for automating testing of an application. The application for testing can be a web application, a desktop application, a mainframe, a mobile application or the like. The application can also include platforms such as enterprise resource planning (ERP), customer relationship management (CRM) or any packaged application. The system 100 includes a user device that comprises a processor 120, a database 140, a memory unit (not shown), one or more input devices 110 and one or more output devices 130. The one or more input devices 110 may include a keyboard and a mouse. The one or more output devices 130 may include at-least a display device. A user performs input actions on the application to be tested by using the one or more input devices 110. The user is simply required to use the application by performing required input actions. Accordingly, a skilled testing professional is not required for performing the required input actions.

In an embodiment a dedicated platform is installed on the user device for automating testing of an application. Upon launching the dedicated platform, the display screen is split into at-least two windows - a first window and a second window. The first window is configured to display the application being monitored/under test whereby the user is allowed to perform input actions within the first window. The second window is configured to simultaneously display outcome of the user's input actions on the application under test. The processor 120 is configured to monitor the application to capture one or more input actions performed by the user on the application. The input actions performed by the user are reflected and visible on the first window of the display device. Input actions include entering text or number in a text box, selecting a value from a combo box, clicking a checkbox, a button, radio button or a hyperlink, selecting an item from a drop-down menu, hover on a control, capturing the state of control and the like. Thereafter, the processor 120 is configured to analyse the input action performed by the user to determine type of input action performed. The analysis is performed by analysing type of element involved in the input action, location of the said element (for example: co-ordinates of the element), and validation of the input action provided by the user (for example: a password field will capture alphanumeric data, or a contact number field will capture numeric data which is ten digits in length). The processor 120 is configured to validate the input action provided by the user. The test scripts (also referred to as “unique test scripts” and/or “script”) that are generated are also validated. Once the type of input action performed by the user is determined, the processor 120 is configured to assign one or more keywords to each determined action. Based on the keywords, a unique test script is determined. The keywords and the unique test scripts corresponding to each of the keywords are pre-determined and stored on the database 140. The database 140 also stores page information of the application for which the test scripts are determined. Such keywords and associated unique test scripts can be updated from time to time to enhance intelligibility of the system 100. In addition, the keywords or test scripts can be edited, if required. The database 140 can also be a remote database of a server/cloud server, wherein the system 100 connects with the server. The second window in the output device 130 displays the page information of the application, the keywords and the test script assigned for respective input actions. Advantageously, each action performed by a user is converted into a test script without any manual intervention, and such test script being created is visible to the user in real time. This is also advantageous from a cost and time perspective.

The unique test script corresponding to each of the pre-determined/input action is stored on the database 140 for being replayed during execution of automatic testing of the application or during debugging of the test scripts. Further, when the user performs a sequence of actions/steps, all such steps in the system 100 are analysed, each action/step in the sequence is assigned corresponding keywords and test scripts, and a complete script is created for the sequence of inputs/steps performed by the user. The complete test script is determined for the input actions performed by the user based on the logical grouping of the unique test scripts and the input action with keywords. When the complete test script is run, the sequence of actions would be performed. Accordingly, the user is required to input data only once in the first window on the output devices 130. All actions/steps are recorded by the system 100 and during replay, the system 100 accesses the test script stored on the database 140. The system 100 is configured to input the same in the required fields to perform the steps multiple times. Therefore, the user needs to input data only for a singular instance and the steps are performed by the system 100 automatically without any manual intervention. Automatic feeding of test data from the database 140 enables the system 100 to complete the testing process quicker compared to an event in which a user has to input each data set manually.

As an example, if the user clicks on a ‘Login’ button in a web application under test, the input action will be captured and determined based on various parameters such as clicking action, type and location of element. Thereafter, a keyword is assigned to the input action which is linked to a test script stored on the database 140. This test script in this instance when run would perform the action of clicking on ‘Login’ button. In an embodiment, the processor 120 is configured to generate a

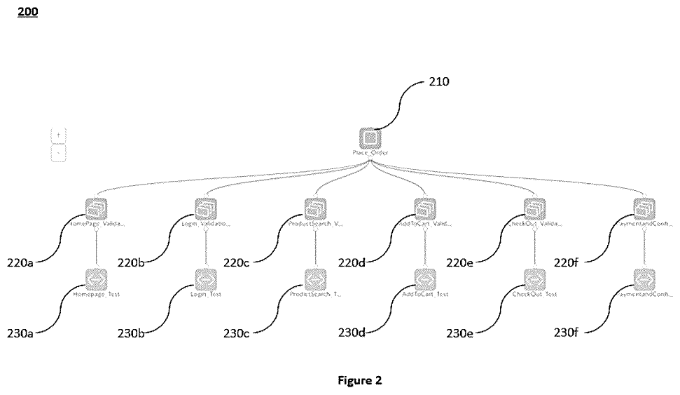

report 200 (as shown in FIG. 2) that includes plurality of interactive links to the test script for each action. The interactive link enables the user to navigate and modify the test script as required. In another embodiment, the report 200 categorizes the application as having one or more modules, and each module has one or more sub-modules. In this regard, the system 100 monitors all screens/pages and elements of a test scenario and their corresponding relationships, and basis the aforesaid, the report 200 is generated in a structured and visual form, and displayed on the second window on the output device 130.

FIG. 2 illustrates the report 200 generated by the system 100 in

accordance with an embodiment of the invention. The report 200 generated for each of the one or more modules has a hierarchical structure, whereby a main module will be a parent node, and each of the one or more sub-modules will be a child node of the parent node. Depending on type of operation (to be tested) of the application, the hierarchical structure will have multiple child nodes. In an embodiment, the report 200 generated has a structure corresponding to a sequence of the input actions performed by the user. In the report 200, each child node will include an interactive link to the test script associated with the action. By way of an example, the report 200 is generated for a website/application of an online shopping portal. In particular, the report 200 is generated upon creating a test script for automated testing of a place order function of the aforesaid website/application. Similar reports are generated for other functions of the website/application. As shown, the report 200 comprises a mind map which has classified, and/or organized functionalities/features of the ‘place order’ module in a hierarchical, visual layout. The mind map has a main module 210 which is a parent node corresponding to the place order module. A plurality of sub-modules 220a to 220f which are sub-features/functions of the main module 210 are child nodes which include a ‘homepage’ module, a ‘login’ module, a ‘product search’ module, an ‘add to cart’ module, a ‘check-out’ module, and a ‘payment’ module. For each of the sub-modules 220a to 220f, a test script is created by the system 100 and each of the sub-modules 220a to 220f have a dedicated link 230a to 230f. Thus, by accessing the corresponding link 230a to 230f, the specific test script can be accessed. Accordingly, when the application is updated or a bug/error is detected on the application, the user does not need to update the entire script from the beginning. Also, the part of the test script which is to be modified can be easily accessed. The user can thus access the relevant sub-module of the report 200 for updating the test script. In this regard, if the test script is required to be updated for particular portion of the application, relevant page of the application is displayed and input actions on the application are captured/recaptured, which would in turn generate/update the test script. The updated test script would thus reflect the steps to be undertaken in the updated application.

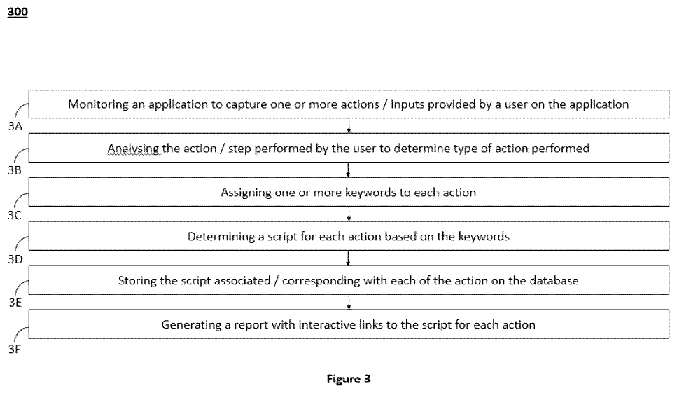

FIG. 3 illustrates a method 300 for automating testing of an application. The method 300 is executed on the system 100 discussed hereinbefore. The method at step 3A, includes monitoring, by a processor 120, the application to capture one or more input actions performed by a user on the application via an input device 110 connected with the processor 120. The input actions are performed by the user are reflected and visible on the first window of the display device. Input actions include entering text or number in a text box, selecting a value from a combo box, clicking a checkbox, a button, radio button or a hyperlink, selecting an item from a drop-down menu, hover on a control, capturing the state of control and the like. Further, the method comprises the step of splitting, a display screen into at least a first window and a second window. As discussed herein before, the first window configured to display the application being monitored whereby the user is performing one or more input actions, and the second window is configured to display page information of the application, the keywords and the unique test scripts being assigned to one or more input actions performed by the user. Thereafter, at 3B, the method 300 includes the step of analysing the input action performed by the user to determine type of action performed. The step of analyzing of one or more input actions performed by the user includes analysing type of element involved in the input action, location of the said element (for example: co-ordinates of the element), and validation of the input action provided by the user (for example: a password field will capture alphanumeric data, or a contact number field will capture numeric data which is ten digits in length). At step 3C, the method 300 performs the step of assigning one or more keywords to each action. Thereafter, at step 3D, determining a unique test script for each action based on the keywords. Each keyword is associated with the unique test script, the keywords and the associated unique test scripts for each action are pre-determined and stored on a database 140. At step 3E, the method 300 includes storing the unique test script associated/corresponding with each of the action on the database 140 for replaying the unique test script during execution of automatic testing of the application. Finally, at step 3F, the method 300 includes generating a report 200 with interactive links to the unique test script for each action, thereby enabling the user to navigate and modify the unique test script as required. The report 200 as shown in FIG. 2 includes one or more modules arranged in a hierarchical structure corresponding with a hierarchical structure of the application, the one or more modules comprise a main module 210 corresponding to a parent node and each of the one or more sub modules (220a-220f) corresponding to a child node of the parent node, and each of the one or more sub modules (220a-220f) include an interactive link.

Advantageously, the present invention provides a system and method for automating testing of an application that does not require the user to input test data for every test case. As the system is configured to analyse, determine and generate a complete script for one or more input actions, testing is automated thereby reducing manual intervention. Such automation saves time, effort and resources of the organization performing the testing. Further, the present invention generates a report with interactive links to the test script for each action, thereby enabling the user to navigate and modify the test script as required.

The foregoing description of the invention has been set merely to illustrate the invention and is not intended to be limiting. Since the modifications of the disclosed embodiments incorporating the spirit and substance of the invention may occur to the person skilled in the art, the invention should be construed to include everything within the scope of the invention.

We claim:

1. A system (100) for automating testing of an application, the system (100) comprising:
a database (140);
a processor (120) configured to:
monitor the application to capture one or more input actions performed by a user on the application via one or more input devices (110) connected with the processor (120);
analyze the one or more input actions to determine a type of input action performed by the user;
assign one or more keywords to each of the input actions performed by the user;
determine a unique test script for each input action based on the assigned keyword, each keyword associated with the unique test script, the keywords and the associated unique test scripts for each input action are pre-determined and stored on the database (140); and
store the unique test script associated with each of the input actions on the database (140) for replaying the unique test script during execution of automatic testing of the application.

2. The system (100) as claimed in claim 1, wherein the processor (120) is configured to:
monitor a sequence of input actions performed by the user;
generate a complete test script for sequence of input actions performed by the user, the complete test script having individual unique test scripts for each of the input actions; and
store the complete test script on the database (140) for replaying the complete test script during execution of automatic testing of the application.

3. The system (100) as claimed in claim 1, wherein the processor (120) is configured to split a display screen into at least a first window and a second window, the first window configured to display the application being monitored whereby the user is performing one or more input actions, and the second window is configured to display page information of the application, the keywords and the unique test scripts being assigned to one or more input actions performed by the user.

4. The system (100) as claimed in claim 1, wherein the analysis of one or more input actions performed by the user includes one of analyzing a type of element involved in the input action, a location of the element and validation of the input action provided by the user.

5. The system (100) as claimed in claim 1, wherein the processor (120) is configured to generate a report (200) comprising plurality of interactive links, each interactive link provides access to the unique test script determined for each input action, enabling the user to navigate and modify the unique test script.

6. The system (100) as claimed in claim 5, wherein the report (200) includes one or more modules arranged in a hierarchical structure corresponding with a hierarchical structure of the application, the one or more modules comprise a main module (210) corresponding to a parent node and each of the one or more sub modules (220a-220f) corresponding to a child node of the parent node, and each of the one or more modules (220a-220f) include an interactive link.

7. A method (300) for automating testing of an application, the method (300) comprising steps of:
monitoring, by a processor (120), the application to capture one or more input actions performed by a user on the application via one or more input devices (110) connected with the processor (120);
analyzing, by the processor (120), the one or more input actions to determine a type of input action performed by the user;
assigning, by the processor (120), one or more keywords to each of the input actions performed by the user;
determining, by the processor (120), a unique test script for each input action based on the assigned keyword, each keyword associated with the unique test script, the keywords and the associated unique test scripts for each input action are pre-determined and stored on a database (140); and
storing, by the processor (120), the unique test script associated with each of the input actions on the database (140) for replaying the unique test script during execution of automatic testing of the application.

8. The method (300) as claimed in claim 7 comprising the steps of:
monitoring, by the processor (120), a sequence of input actions performed by the user;
generating, by the processor (120), a complete test script for sequence of input actions performed by the user, the complete test script having individual unique test scripts for each of the input actions;
and storing, by the processor (120), the complete test script on the database (140) for replaying the complete test script during execution of automatic testing of the application.

9. The method (300) as claimed in claim 7 comprising the step of splitting, by the processor (120), a display screen into at least a first window and a second window, the first window configured to display the application being monitored whereby the user is performing one or more input actions, and the second window is configured to display page information of the application, the keywords and the unique test scripts being assigned to one or more input actions performed by the user.

10. The method (300) as claimed in claim 7, wherein the analysis of one or more input actions performed by the user includes one of analyzing a type of element involved in the input action, a location of the element and validation of the input action provided by the user.

11. The method (300) as claimed in claim 7 comprising the step of generating, by the processor (120), a report (200) comprising plurality of interactive links, each interactive link provides access to the unique test script determined for each input action, enabling the user to navigate and modify the unique test script.

12. The method (300) as claimed in claim 11, wherein the report (200) includes one or more modules arranged in a hierarchical structure corresponding with a hierarchical structure of the application, the one or more modules comprise a main module (210) corresponding to a parent node and each of the one or more sub modules (220a-220f) corresponding to a child node of the parent node, and each of the one or more modules (220a-220f) include an interactive link.
